(19) United States
(12) Patent Application Publication
(10) Pub. No.: US 2007/0146339 A1
(43) Pub. Date: Jun. 28, 2007

(54) Mobile apparatus for providing user interface and method and medium for executing functions using the user interface

(75) Inventors: Gyung-hye Yang, Seoul (KR); Kyu-yong Kim, Yongin-si (KR); Sang-youn Kim, Seoul (KR); Byung-seok Soh, Suwon-si (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/485,342

(22) Filed: Jul. 13, 2006

(30) Foreign Application Priority Data
Dec. 28, 2005 (KR) 10-2005-0132050

(51) Int. Cl. G09G 5/00

(52) U.S. Cl. 345/173

(57) ABSTRACT

A mobile apparatus for providing a user interface and method and medium for executing functions using the user interface are provided. The mobile apparatus includes a user interface module sensing a user's touch and providing information regarding the user's touch, and a control module determining a type of mode and function selected by a user based on the provided information regarding the user's touch, wherein the user interface module provides a user interface pad by which mode items and function items corresponding to the mode items are simultaneously formed, and the user interface module includes a first area for selecting mode items corresponding to the type of mode and function determined by the control module, a second area for selecting the function items, and a common area of the first and second areas, and the control module executes a function positioned at the common area.

### CROSS-REFERENCE TO RELATED APPLICATIONS

This application claims the benefit of Korean Patent Application No. 10-2005-0132050 filed on Dec. 28, 2005, in the Korean Intellectual Property Office, the disclosure of which is incorporated herein by reference in its entirety.

### BACKGROUND OF THE INVENTION

1. Field of the Invention

The present invention relates to a user interface, and more particularly, to a mobile apparatus for providing a user interface enabling a user to easily access functions of a desired mode by providing mode items and function items for the respective mode items to a single user interface, and a method and medium for executing functions using the user interface.

2. Description of the Related Art

In accordance with recent technological developments in electronics and communications, various types of devices rendering a wide variety of functions rather than a particular function have been developed and are being widely sold and used.

To allow users to perform desired functions, such devices have various user interfaces such as 4-directional keys, a touch panel, or a joystick. At this time, in order to select function items necessary for performing a function desired by a user, the user should take several navigation steps, which will now be described with reference to FIG. 1.

Referring to FIG. 1, a conventional mobile apparatus provides mode items 110, for example, mode A, mode B, and mode C. In other words, when a user operates the conventional mobile apparatus, a mode menu including the modes is displayed on a display screen mounted in the conventional mobile apparatus. That is to say, the conventional mobile apparatus operates in a particular mode selected by a user.

In FIG. 1, reference numeral 120 indicates function items offered in the respective modes.

For example, when a user intends to execute a function A-3-2 in mode A using the mobile apparatus, the user selects the mode A item in the mode menu. If the user selects the mode A item, A-1, A-2, and A-3 function items offered in mode A are displayed on the display screen of the mobile apparatus. When the user selects the A-3 function item, A-3-1 and A-3-2 function items, which are sub function items of the A-3 function item, are displayed on the display screen of the mobile apparatus and then the function desired by the user, that is, the function A-3-2, can be executed by selecting the A-3-2 function item.

Meanwhile, when the user intends to execute a function C-2 offered in mode C in the course of executing the function A-3-2, the user has to move back to the first display screen, i.e., the mode menu, and to select an item mode C. When the mode C item is selected, function item C-1 and function item C-2 are displayed on the display screen, and the user selects the C-2 function item to execute the function desired by the user. Alternatively, the user continuously moves toward upper items from the function item A-3-2 and selects function item mode C and function item C-2 in turn when the mode menu is finally displayed, so that the user's desired function can be executed.

In other words, in order to change a function intended to be executed from a function in one mode to a function in another mode in an apparatus supporting multiple modes, it is necessary to perform item selection steps based on navigation several times, which is quite inconvenient.

Meanwhile, a mobile apparatus, which allows user mobility, enables a user to visually identify items while moving and to manipulate several times modes or functions for the respective modes based on navigation using a user interface attached to the mobile apparatus. That is to say, the greater the number and variety of mode items and function items, the greater the number of navigation trials that should be attempted by a user.

In addition, a user interface area of a mobile device, for example, the area of a user interface for inputting a command for executing a function desired by a user, is relatively narrow, which may lower the usability of the mobile apparatus.

Accordingly, there exists a need for a mobile apparatus for providing a variety of modes and functions, which enables a user to more easily execute a particular function and to intuitively manipulate the command input through a user interface.

### SUMMARY OF THE INVENTION

Additional aspects, features, and/or advantages of the invention will be set forth in part in the description which follows and, in part, will be apparent from the description, or may be learned by practice of the invention.

The present invention provides a mobile apparatus for providing a user interface enabling a user to easily access functions of a desired mode by providing mode items and function items for the respective mode items to a single user interface.

The present invention also provides a method and medium of intuitively manipulating a user's function execution command using the user interface.

The present invention also provides a user interface implemented as a haptic interface.

According to an aspect of the present invention, there is provided a mobile apparatus including a user interface module sensing a user's touch and providing information regarding the user's touch, and a control module determining a type of mode and function selected by a user based on the provided information regarding the user's touch, wherein the user interface module provides a user interface pad by which mode items and function items corresponding to the mode items are simultaneously formed, and the user interface module includes a first area for selecting mode items corresponding to the type of mode and function determined by the control module, a second area for selecting the function items, and a common area of the first and second areas, and the control module executes a function positioned at the common area.

According to another aspect of the present invention, there is provided a mobile apparatus including a mode selecting area for providing modes divided according to kinds of contents executed, a function selecting area for providing functions corresponding to the modes, and a common area of the mode selecting area and the function selecting area, wherein the mode selecting area or the function selecting area is moved according to movement of a user's touch, and the common area is moved according to the movement of the user's touch.

According to still another aspect of the present invention, there is provided a method for executing a common area function including (a) forming a mode selecting area for providing modes divided according to kinds of contents executed, and a function selecting area for providing functions corresponding to the modes, (b) forming a common area of the mode selecting area and the function selecting area, and (c) executing the common area function positioned in the common area.

According to still another aspect of the present invention, there is provided a mobile apparatus including a user interface module sensing a user's touch and providing information regarding the user's touch, wherein the user interface module provides a user interface pad by which mode items and function items corresponding to the mode items are simultaneously formed, and the user interface module includes a first area for selecting mode items corresponding to type of mode and function, a second area for selecting the function items, and a common area of the first and second areas for selecting function item so that the function corresponding to the function item is executed.

According to still another aspect of the present invention, there is provided a computer readable medium storing instructions that control a processor to perform a method for executing a common area function including (a) forming a mode selecting area for providing modes divided according to kinds of contents executed, and a function selecting area for providing functions corresponding to the modes; (b) forming a common area of the mode selecting area and the function selecting area; and (c) executing the common area function positioned in the common area.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates mode items and function items for the respective modes, which are provided by a conventional mobile apparatus;

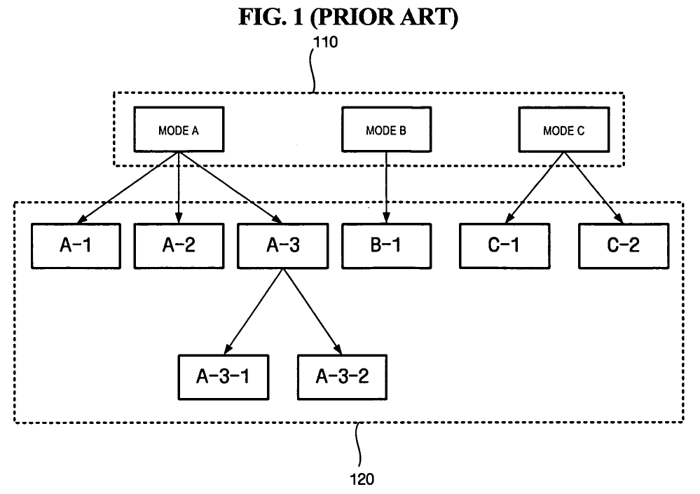

FIG. 2 illustrates an exemplary structure of a mobile apparatus according to an exemplary embodiment of the present invention;

FIG. 3 illustrates an example of a user interface according to an exemplary embodiment of the present invention;

FIGS. 4A and 4B illustrate a method for executing functions using a user interface, according to an exemplary embodiment of the present invention;

FIG. 5 illustrates an exemplary structure of a user interface according to another exemplary embodiment of the present invention;

FIG. 6 is a block diagram of a mobile apparatus according to an exemplary embodiment of the present invention;

FIG. 7 is a flowchart illustrating the method for executing functions using a user interface shown in FIGS. 4A and 4B; and

FIGS. 8A and 8B illustrate a user interface pad constructed using an electroactive polymer (EAP) according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instructions that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur in a different order. For example, two blocks shown in succession may in fact be executed substantially concurrently or the blocks may sometimes be executed in the reverse order, depending upon the functionality involved.

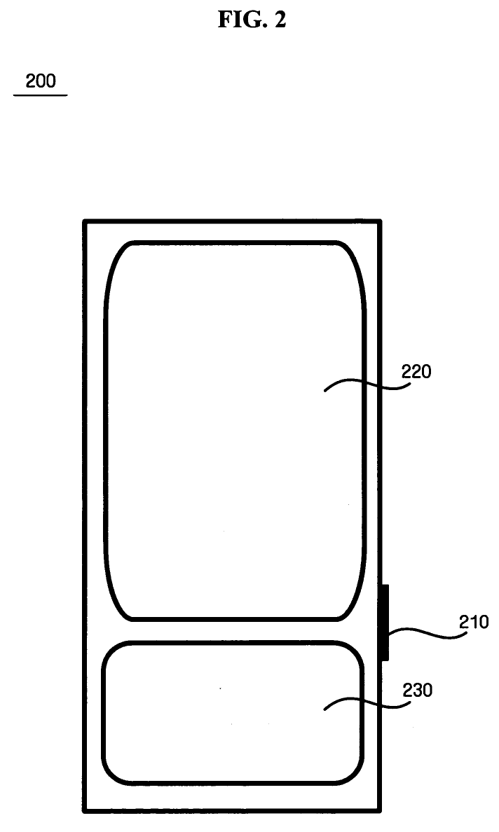

FIG. 2 illustrates an exemplary structure of a mobile apparatus according to an exemplary embodiment of the present invention. Referring to FIG. 2, the mobile apparatus 200 according to an exemplary embodiment of the present invention includes a power controller 210, a user interface pad 230, and a display screen 220.

The power controller 210 controls a power supply necessary for the operation of the mobile apparatus 200. Although the power controller 210 is attached to a lateral surface of the mobile apparatus 200, as shown in FIG. 2, the location or size of the power controller 210 attached to the mobile apparatus 200 is not limited to the illustration.

The display screen 220 displays content such as a picture or a moving picture in response to the manipulation of the user interface pad 230.

The user interface pad 230 enables the user to select the mode items and the function items corresponding to the mode items, which are simultaneously displayed on the display screen 220.

Here, the term ‘mode’ used in the present invention can be classified according to the kind of content executed by the mobile apparatus 200, and examples thereof include an ‘Image’ mode for displaying a photo, an ‘Mp3’ mode for playing music in an ‘Mp3’ format, a ‘Movie’ mode for playing a moving picture, and so on. The term ‘function’ refers to a function provided in a particular mode.

The user interface pad 230 of the present invention simultaneously provides modes provided by the mobile apparatus 200 and the functions of the respective modes. That is to say, modes that include the corresponding (or overlapping) functions are incorporated into a single interface.

For example, the ‘Mp3’ mode and the ‘Movie’ mode may include the function items Play, Pause, Stop, F.F, and REW, i.e., both modes may have these function items in common.

The user interface pad 230 may be provided in the form of a touch screen or a haptic device using an electroactive polymer (EAP).

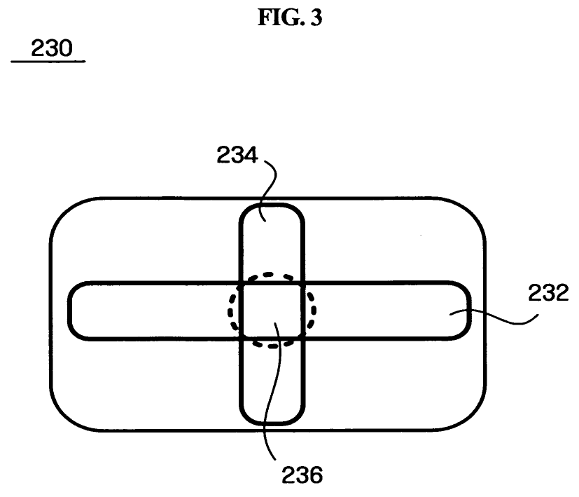

An example of a user interface provided by the user interface pad 230 is illustrated in FIG. 3.

Referring to FIG. 3, the user interfaces include a mode selection strip (or “region”) 232, a function selection strip 234, and a common area 236 shared by the mode selection strip 232 and the function selection strip 234. Here, a function in a mode corresponding to the common area 236 is executed in response to a user's manipulation of the user interface.

The user manipulates the mode selection strip 232 to select a mode provided by the mobile apparatus, and manipulates the function selection strip 234 to select a function of the selected mode.

Referring to FIG. 3, the mode selection strip 232 is placed in a horizontal direction, the function selection strip 234 is placed in a vertical direction, and the intersection therebetween corresponds to the common area 236. However, the mode selection strip 232 and the function selection strip 234 according to the invention are not limited to the shape and location illustrated in FIG. 3, and the user interface according to the present invention may be modified in various manners as long as it includes a mode item area, a function item area, and a common area therebetween.

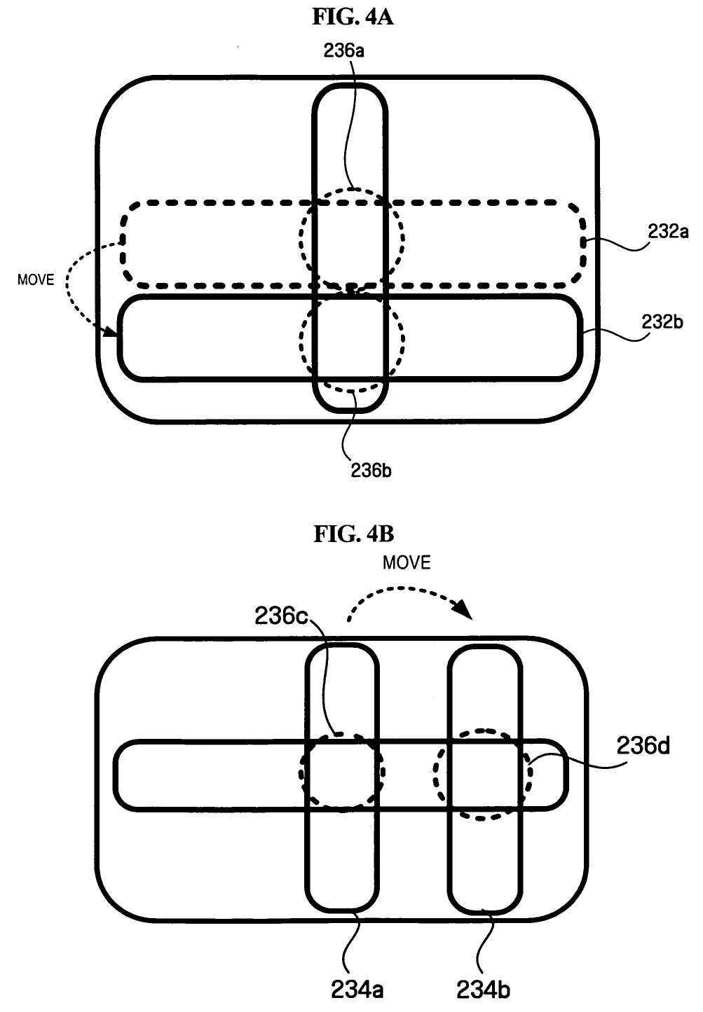

FIGS. 4A and 4B illustrate a method of executing functions using a user interface, according to an exemplary embodiment of the present invention.

Referring to FIG. 4A, the mode selection strip moves from an area 232a to an area 232b in response to a user's finger touch. It is assumed that a function item positioned at a common area 236a of the mode selection strip and the function selection strip is executed when the mode selection strip is positioned in the area 232a. At this time, the user's finger is moved downward in a state in which the user touches the mode selection strip positioned in the area 232a, and the mode selection strip moves to the area 232b. In this case, the function being executed is interrupted.

When the mode selection strip is positioned in the area 232b, a new common area 236b of the mode selection strip and the function selection strip is created.

At this time, when the new common area 236b is held for a predetermined time or longer or the user continuously touches the new common area 236b for a predetermined time or longer after the user's finger is moved to the new common area 236b, a function item positioned in the new common area 236b in a new mode is executed. In addition, when the user applies pressure to the new common area 236b with his/her fingertips, a function item positioned in the new common area 236b can also be executed.

Here, since the function selection strip is not moved, only the mode items of the function items positioned at the previous common area 236a and the new common area 236b change, while function items positioned at the previous common area 236a and the new common area 236b are retained without being changed.

Referring to FIG. 4B, the function selection strip is moved from the area 234a to the area 234b in response to a user's finger touch. It is assumed that a function item positioned at a common area 236c of the mode selection strip and the function selection strip is executed when the mode selection strip is positioned in the area 234a. At this time, the user's finger is moved rightward in a state in which the user touches the function selection strip positioned in the area 234a, and the function selection strip moves to the area 234b. Then, the function being executed is interrupted.

When the function selection strip is positioned in the area 234b, a new common area 236d of the mode selection strip and the function selection strip is created.

At this time, when the new common area 236d is held for a predetermined time or longer or the user continuously touches the new common area 236d for a predetermined time or longer after the user's finger is moved to the new common area 236d, a function item positioned in the new common area 236d in a new mode is executed. In addition, when the user applies pressure to the new common area 236d with his/her fingertips, a function item positioned in the new common area 236d can also be executed.

Here, since the mode selection strip is not moved, only the function items positioned at the previous common area 236c and the new common area 236d change, while mode items positioned at the previous common area 236c and the new common area 236d are retained without being changed.

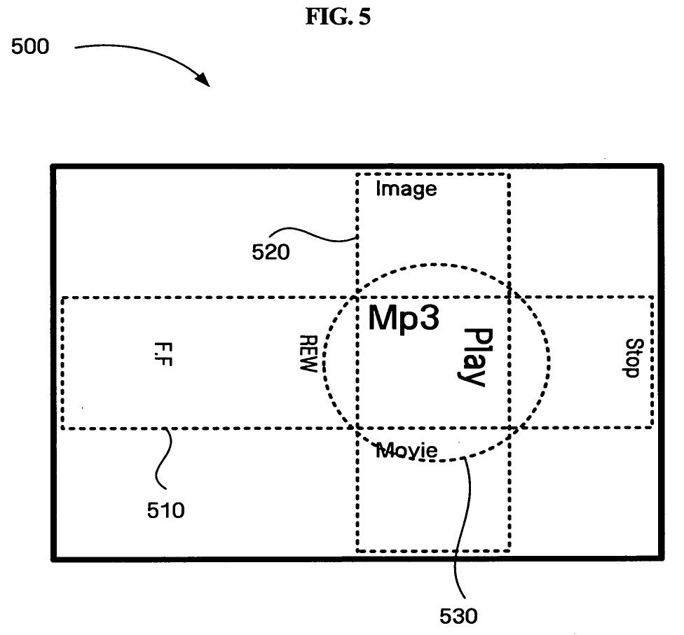

FIG. 5 illustrates an exemplary structure of a user interface 500 according to another exemplary embodiment of the present invention.

Referring to FIG. 5, the user interface 500 includes a mode selection strip 510 for selecting one mode among an ‘Image’ mode, an ‘Mp3’ mode, and a ‘Movie’ mode; a function selection strip 520 for selecting one function among a ‘F.F’ function, a ‘REW’ function, a ‘Play’ function, and a ‘Stop’ function; and a common area 530 shared by the mode selection strip 510 and the function selection strip 520.

Here, the ‘Image’ mode is a mode for displaying a still image or photo, the ‘Mp3’ mode is a mode for processing a music file in an ‘Mp3’ format, and the ‘Movie’ mode is a mode for playing a movie or a moving picture. In addition, the ‘F.F’ function is a function for fast forwarding content in the same direction as the current play direction, the ‘REW’ function is a function for rewinding content in a reverse direction to the current play direction, the ‘Play’ function is a function for playing content, and the ‘Stop’ function is a function for interrupting or stopping content currently being played.

Referring to FIG. 5, since the ‘Mp3’ mode is selected by the mode selection strip 510, and the ‘Play’ function is selected by the function selection strip 520, the mobile apparatus operates as an apparatus for playing back a music file in an ‘Mp3’ format.

While FIG. 5 illustrates ‘Image’, ‘Mp3’, and ‘Movie’ as exemplary modes and ‘F.F’, ‘REW’, ‘Play’, and ‘Stop’ as exemplary functions, the modes and functions according to the present invention are not limited the illustrated examples. For example, a ‘mode’ according to the present invention may encompass an application in which functions for executing a particular mode are the same with each other. In addition, a ‘function’ according to the present invention may encompass a function if the function is necessary in common for manipulation of the particular mode.

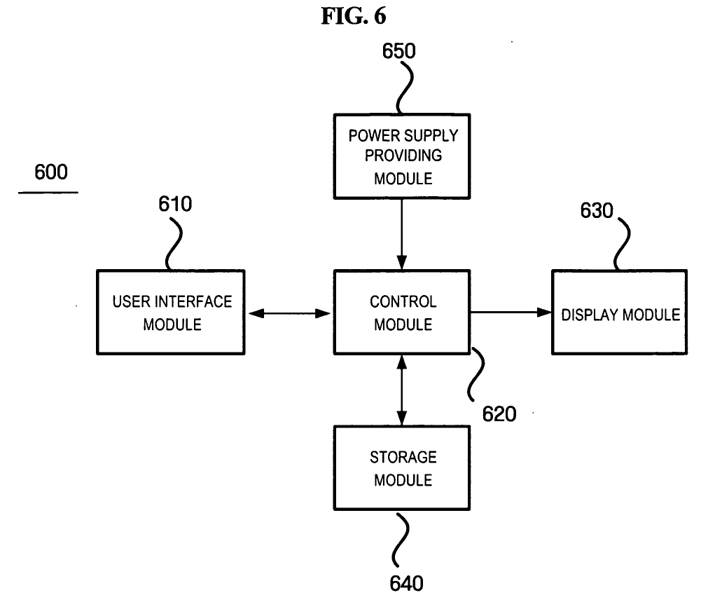

FIG. 6 is a block diagram of a mobile apparatus according to an exemplary embodiment of the present invention.

Referring to FIG. 6, a mobile apparatus 600 according to the present invention includes a user interface module 610, a control module 620, a display module 630, a storage module 640, and a power supply module 650.

The term ‘module’, as used herein, refers to, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The power supply module 650 controls the power supply necessary for the operation of the mobile apparatus 600. The power supply module 650 includes batteries or cells and may be configured to be turned on/off by a user's manipulation.

If the power is supplied to the control module 620 from the power supply module 650, the control module 630 activates the user interface module 610, the storage module 640 and the display module 630 to operate the mobile apparatus 600.

The storage module 640 stores a variety of contents such as photos, moving pictures, music files, and so on.

The display module 630 provides the display screen 220 shown in FIG. 2 under the control of the control module 620, so that the contents stored in the storage module 640 are displayed by manipulation of the user interface module 610.

The user interface module 610 provides the user interface pad 230 shown in FIG. 2, and senses a user's touch from the user interface pad 230, then delivers the result of sensing to the control module 620.

The control module 620 determines the user's selected mode and function based on information regarding the user's touch delivered from the user interface module 610. Here, the information regarding the user's touch may include a user's finger touch location, an orientation in which the user's touch proceeds, or the like.

Accordingly, the information allows the control module 620 to be informed which of either a mode selection strip or a function selection strip is currently being moved by the user, or which function has been selected by the user.

The user interface module 610 may be implemented by a touch screen or a haptic device using EAP.

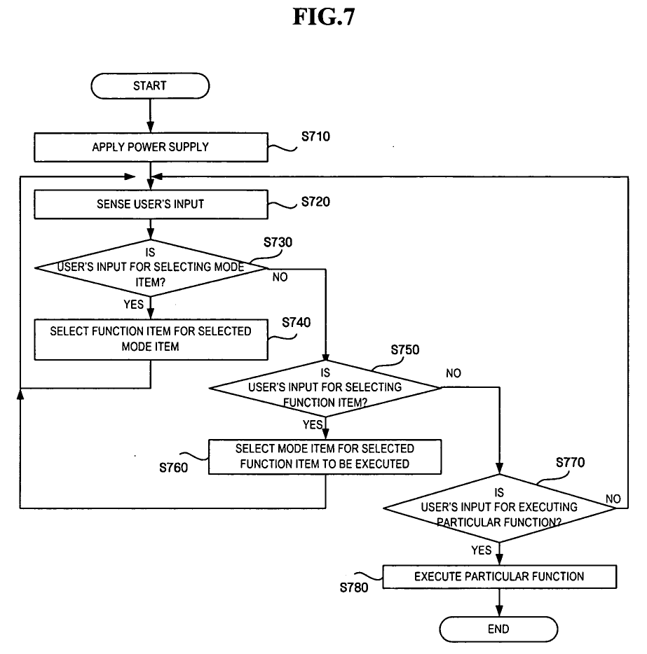

FIG. 7 is a flowchart illustrating the method for executing functions using a user interface shown in FIGS. 4A and 4B.

When a power supply is applied to the mobile apparatus, the mobile apparatus is placed in a standby state until the user's input is sensed (operation S710).

If the user's input is sensed through an interface device such as a user interface pad shown in FIG. 2 (operation S720), it is determined whether the user's input is an input for selecting a mode item (operation S730). Here, the user's input is preferably input through a user's finger touch.

If it is determined in operation S730 that the user's input is an input for selecting a mode item, a function item for the selected mode item is selected (operation S740). Here, as soon as a mode is selected by a user's moving of the mode selection strip 232 shown in FIG. 3, the function selection strip 234 may be formed at an arbitrary location on the user interface pad 230.

Conversely, if it is determined in operation S730 that the user's input is not an input for selecting a mode item, it is determined whether the user's input is an input for selecting a function item (operation S750). Here, the user's input is preferably input through a user's finger touch.

If it is determined in operation S750 that the user's input is an input for selecting a function item, a mode item for the selected function item is selected (operation S760). Here, as soon as a mode is selected by a user's moving of the function selection strip 234 shown in FIG. 3, the mode selection strip 232 may be formed at an arbitrary location on the user interface pad 230.

Conversely, if it is determined in operation S750 that the user's input is not an input for selecting a function item, it is determined whether the user's input is an input for executing a particular function (operation S770). Here, the user's input is preferably input through a user's finger touch.

If it is determined in operation S770 that the user's input is an input for executing the function, the function is executed (operation S780).

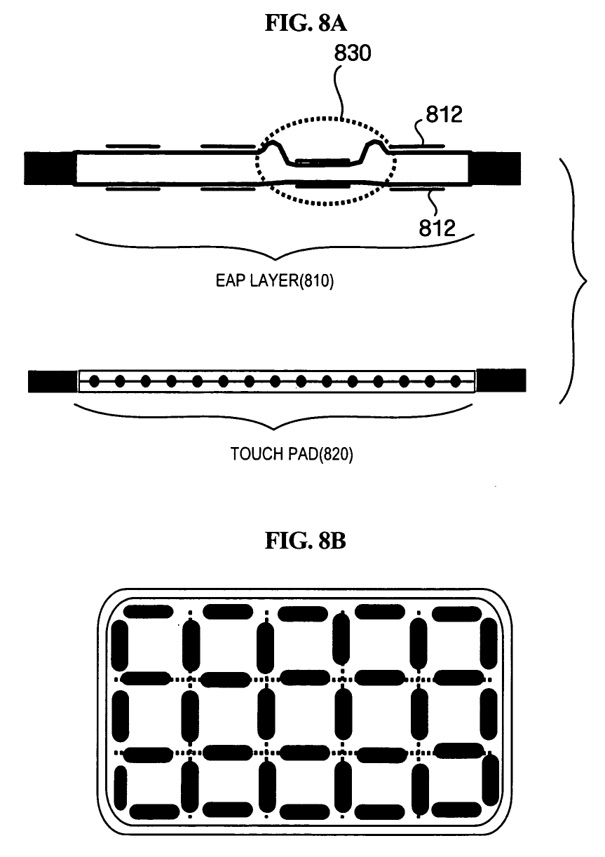

Meanwhile, the user interface pad 230 shown in FIG. 2 may be implemented using EAP, which is illustrated in FIGS. 8A and 8B.

EAP is a kind of polymer prepared and processed to have a wide range of physical and electrical properties.

Once activated upon application of a voltage, the EAP exhibits considerable movement or strain, generally called deformation. Such strain may differ depending on the length, width, thickness, or radial direction of a material of the polymer, and it is known that the strain is in a range of 10% to 50%, which is a very characteristic feature compared to a piezoelectric element which exhibits a strain only as high as about 3%, and is advantageous in that it can be almost completely controlled by a suitable electric system.

Since the EAP outputs an electric signal corresponding to an external physical strain applied, if any, it can be used as sensor as well. Since materials of EAP typically generate a potential difference that can be electrically measured, the EAP can be used as a sensor of force, location, speed, accelerated speed, pressure, and so on. In addition, since the EAP exhibits bidirectional properties, it can also be used as a sensor or an actuator.

FIG. 8A illustrates a cross-sectional view of a user interface pad 230. Referring to FIG. 8A, the user interface pad 230 includes an EAP layer 810 and a touch pad 820. The EAP layer 810 includes a plurality of electrodes 812. If a voltage is applied to the user interface pad 230, strain of the EAP occurs at the plurality of electrodes 812 and in the vicinity thereof. The strain of the EAP is an area indicated by reference numeral 830. The mode selection strip or the function selection strip may be formed by the EAP having such a strain.

If the touch pad 820 senses the user's finger touch, a predetermined voltage is applied to horizontal or vertical electrodes disposed at the sensed location, resulting in strain of the EAP, thereby forming a mode selection strip or a function selection strip. Here, the user feels the sense of touch with respect to the mode selection strip or the function selection strip while touching the user interface pad 230 with his/her fingertips.

FIG. 8B is a plan view of the user interface pad 230. The plurality of electrodes 812 of the EAP layer 810 may be arranged in such a manner as shown in FIG. 8B, to form the mode selection strip or the function selection strip.

Meanwhile, a metal-dome switch may be incorporated into the user interface pad 230, thereby providing for the sense of manipulation of inputs and outputs.

According to the present invention, the user can easily access functions of a desired mode provided by a mobile device.

In addition, the present invention allows the user to intuitively manipulate commands for executing functions.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of program instructions include both machine code, such as produced by a compiler, and files containing higher level code that may be executed by the computer using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission (such as transmission through the Internet). Examples of wired storage/transmission media may include optical wires/lines, metallic wires/lines, and waveguides. The medium/media may also be a distributed network, so that the computer readable code/instructions is stored/transferred and executed in a distributed fashion. The computer readable code/instructions may be executed by one or more processors. In addition, the above hardware devices may be configured to act as one or more software modules in order to perform the operations of the above-described exemplary embodiments.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A mobile apparatus comprising:
a user interface module sensing a user's touch and providing information regarding the user's touch; and
a control module determining a type of mode and function selected by a user based on the provided information regarding the user's touch,
wherein the user interface module provides a user interface pad by which mode items and function items corresponding to the mode items are simultaneously formed, and the user interface module includes a first area for selecting mode items corresponding to the type of mode and function determined by the control module, a second area for selecting the function items, and a common area of the first and second areas, and the control module executes a function positioned at the common area.

2. The mobile apparatus of claim 1, wherein the information contains information regarding the location of the user's touch.

3. The mobile apparatus of claim 1, wherein the information contains information regarding the orientation in which the user's touch proceeds.

4. The mobile apparatus of claim 1, wherein the user interface pad includes a touch pad for sensing the information and an electroactive polymer (EAP) layer for forming the first and second areas using strain occurring in the EAP layer.

5. The mobile apparatus of claim 1, wherein the user interface pad is formed by a touch screen.

6. The mobile apparatus of claim 1, wherein the control module executes a function item positioned at the common area when the common area is held for a predetermined time or longer.

7. The mobile apparatus of claim 1, wherein the control module executes a function positioned in the common area when the user's touch is continuously held in the common area for a predetermined time or longer.

8. The mobile apparatus of claim 1, wherein the control module executes a function positioned in the common area when pressure due to the user's touch is applied to the common area.

9. A mobile apparatus comprising a mode selecting area for providing modes divided according to kinds of contents executed, a function selecting area for providing functions corresponding to the modes, and a common area of the mode selecting area and the function selecting area, wherein the mode selecting area or the function selecting area is moved according to movement of a user's touch, and the common area is moved according to the movement of the user's touch.

10. The mobile apparatus of claim 9, wherein the mode selecting area and the function selecting area are determined by the user's touch.

11. The mobile apparatus of claim 10, wherein the user interface includes a touch pad for sensing the information and an electroactive polymer (EAP) layer for forming the mode selecting area and the function selecting area using strain occurring in the EAP layer.

12. The mobile apparatus of claim 10, wherein the user interface is formed by a touch screen.

13. The mobile apparatus of claim 9, wherein the control module executes a function positioned in the common area when the common area is held for a predetermined time or longer.

14. The mobile apparatus of claim 9, wherein the control module executes a function positioned in the common area when the user's touch is continuously held in the common area for a predetermined time or longer.

15. The mobile apparatus of claim 9, wherein the control module executes a function positioned in the common area when pressure due to the user's touch is applied to the common area.

16. A method for executing a common area function comprising:
(a) forming a mode selecting area for providing modes divided according to kinds of contents executed, and a function selecting area for providing functions corresponding to the modes;
(b) forming a common area of the mode selecting area and the function selecting area; and
(c) executing the common area function positioned in the common area.

17. The method of claim 16, wherein the mode selecting area and the function selecting area are determined by the user's touch.

18. The method of claim 16, wherein the user interface includes a touch pad for sensing the information and an electroactive polymer (EAP) layer for forming the mode selecting area and the function selecting area using strain occurring in the EAP layer.

19. The method of claim 16, wherein operation (c) comprises executing the common area function positioned in the common area when the common area is held for a predetermined time or longer.

20. The method of claim 16, wherein operation (c) comprises executing the common area function positioned in the common area when the user's touch is continuously held in the common area for a predetermined time or longer.

21. The method of claim 16, wherein operation (c) comprises executing the common area function positioned in the common area when pressure due to the user's touch is applied to the common area.

22. A mobile apparatus comprising:
a user interface module sensing a user's touch and providing information regarding the user's touch,
wherein the user interface module provides a user interface pad by which mode items and function items corresponding to the mode items are simultaneously formed, and the user interface module includes a first area for selecting mode items corresponding to type of mode and function, a second area for selecting the function items, and a common area of the first and second areas for selecting function item so that the function corresponding to the function item is executed.

23. A computer readable medium storing instructions that control a processor to perform a method for executing a common area function comprising:
(a) forming a mode selecting area for providing modes divided according to kinds of contents executed, and a function selecting area for providing functions corresponding to the modes;
(b) forming a common area of the mode selecting area and the function selecting area; and
(c) executing the common area function positioned in the common area.
